(19) United States
(12) Patent Application Publication
(10) Pub. No.: US 2025/0370116 A1
(43) Pub. Date: Dec. 4, 2025

(54) Method for locating a vertical landing aircraft with respect to a landing pad and associated devices

(71) Applicant: THALES, Meudon (FR)

(72) Inventors: Baptiste LEFEVRE, MERIGNAC (FR); Marc DA CONCEICAO, TOULOUSE CEDEX 01 (FR); Pierre HARAMBILLET, MERIGNAC (FR); Pierre MARIANI, MERIGNAC (FR); François MICHEL, MERIGNAC (FR); Yoan VEYRAC, MERIGNAC (FR)

(21) Appl. No.: 19/214,034

(22) Filed: May 21, 2025

(30) Foreign Application Priority Data
May 29, 2024 (FR) 2405554

(51) Int. Cl. G01S 13/42; B64F 1/18; G01S 13/933

(52) U.S. Cl. CPC G01S 13/42; B64F 1/18; G01S 13/933

(57) ABSTRACT

A method for locating an aircraft with respect to a landing pad including reflective elements, the method including reception of a reflected signal including a plurality of measurement points presenting a characteristic magnitude, filtering of the plurality of measurement points according to a criterion, determination of a set of filtered measurement points respecting a condition of number and/or relative positioning of the measurement points, selection of a set among the determined sets by minimizing a position offset between the real measurement points and the expected measurement points, and localization of the aircraft based on the positions of the measurement points of the selected set.

### REFERENCE TO RELATED APPLICATION

This application is a U.S. non-provisional application claiming the benefit of French Patent Application No. 24 05554 filed on Apr. 29, 2024, the contents of which are incorporated herein by reference in their entirety.

### TECHNICAL FIELD OF THE INVENTION

This invention relates to a method for locating an aircraft with respect to a landing pad. This invention also relates to the associated devices, namely a locating device and a landing pad.

The invention relates to the field of aircraft, notably autonomous vertical landing aircraft, more particularly the field of locating these during takeoff and landing phases.

### BACKGROUND OF THE INVENTION

It is crucial to be able to locate an aircraft with respect to the landing pad on which it can land or take off to ensure a satisfactory level of safety during takeoff and landing phases.

The so-called “vertical” landing of certain aircraft involves specific landing procedures and the use of landing pads adapted to these procedures, commonly called heliport or vertiport.

Typically, the landing pads are circular in shape and have a diameter of about 25 meters (m).

The approach speed of an aircraft seeking to land on such a landing pad requires rapid localization of the latter.

For this, a reference system is known in ILS (“Instrument Landing System”) technology relating to the localization of an aircraft with respect to a landing pad during the landing phase.

This technology uses transmitting antennas present at the end of the landing pad the sum of the signals from the antennas received by the aircraft being characterized by a carrier signal and a modulation signal, same being direct functions of the lateral and longitudinal offsets of the aircraft with respect to the reference approach axis in the vertical and horizontal plane.

However, this technology is costly and therefore quite rarely deployed and does not allow for the detection of potential obstacles on the landing pad.

Moreover, this technology is not used during takeoff and is not necessarily adapted to vertical landing.

There is therefore a need for a method for locating a vertical landing aircraft with respect to a landing pad whose implementation is easy.

### SUMMARY OF THE INVENTION

To this end, the description describes a method for locating an aircraft with respect to a landing pad on which aircraft can land or take off, the landing pad including a plurality of reflective elements for a radio signal, the plurality of reflective elements being arranged according to a spatial arrangement, the method comprising the following phases:
emission of a radio signal from the aircraft to the landing pad,
reception of a signal reflected by the landing pad in response to the emitted radio signal, the reflected signal including a plurality of measurement points, each measurement point being defined by a position and presenting at least one characteristic magnitude,
filtering of the plurality of measurement points according to at least one criterion depending on the at least one characteristic magnitude, to obtain filtered measurement points,
determination of at least one set of filtered measurement points meeting a condition of number and/or relative positioning of the measurement points, to obtain determined sets,
selection of a set among the determined sets by minimizing a position offset between the real measurement points and the expected measurement points after reflection by the plurality of reflective elements, to obtain a selected set, and
localization of the aircraft with respect to the landing pad based on the positions of the measurement points of the selected set.

According to other advantageous aspects, the localization method includes one or more of the following characteristics, taken individually or according to all technically possible combinations:
the selection step includes the following sub-steps:
determination of at least one base change variable between the radar reference and the landing pad reference,
calculation of the plurality of position errors, a position error being associated with a group of reflective elements and being calculated based on the at least one base change variable and the positions in the radar reference of the measurement points forming the group of reflective elements, and
identification of the selected set, the selected set being the group of reflective elements the position error of which is the lowest.
   the filtering step is implemented according to two criteria, each criterion depending on the value of a respective characteristic magnitude.
at least one characteristic magnitude is the reflected power or the doppler speed.
   a criterion is that the reflected power is included between two thresholds.
   a diameter of the landing pad is defined, a condition of relative positioning being that the distance between the measurement points of the determined set is less than twice the diameter of the landing pad.
   the radio signal belongs to a frequency band chosen among the X, K, Ka, Ku, and W bands.
   according to the spatial arrangement, a first half of the reflective elements is aligned along a first line tangent to the landing pad and a second half of the reflective elements is aligned along a second line distinct from the first line and also tangent to the landing pad.
   the reflective elements are offset by a distance with respect to the reflective elements along a longitudinal axis U.
each of the reflective elements of the same line are spaced from each other according to a predetermined line spacing.
   the aircraft is an airplane, a helicopter, or a drone.

The description also relates to a localization device for a vertical landing aircraft with respect to a landing pad on which aircraft can land or take off, the landing pad including a plurality of reflective elements for a radio signal, the plurality of reflective elements being arranged according to a spatial arrangement, the localization device including a calculator configured to:
emit a radio signal from the aircraft to the landing pad,
receive a signal reflected by the landing pad in response to the emitted radio signal, the reflected signal including a plurality of measurement points, each measurement point being defined by a position and presenting at least one characteristic magnitude,
filter the plurality of measurement points according to at least one criterion depending on the value of the characteristic magnitude, to obtain filtered measurement points,
determine at least one set of filtered measurement points meeting a condition of relative positioning of the measurement points, to obtain determined sets,
select a set among the determined sets by minimizing a position offset between the real measurement points and the expected measurement points after reflection by the plurality of reflective elements, to obtain a selected set, and
locate the aircraft with respect to the landing pad based on the positions of the measurement points of the selected set.

The description also describes a landing pad on which aircraft can land or take off, the landing pad having a shape adapted for vertical landing and including a plurality of reflective elements for a radio signal arranged on an edge of the landing pad.

According to one embodiment, at least one reflective element is a trihedral reflector.

In the following description, a magnitude is substantially equal to a value when the magnitude is greater than or equal to 90% of the value and the magnitude is less than or equal to 110% of the value.

### BRIEF DESCRIPTION OF THE DRAWINGS

The invention will appear more clearly upon reading the following description, given solely by way of non-limiting example and made with reference to the drawings in which:

FIG. 1 is a schematic representation of a top view of an aircraft including a localization device and landing on a landing pad;

FIG. 2 is a flowchart illustrating an example of implementation of a method for locating an aircraft with respect to a landing pad; and

FIG. 3 is a flowchart illustrating an example of implementation of a selection step of the method for locating an aircraft with respect to a landing pad.

### DETAILED DESCRIPTION OF THE INVENTION

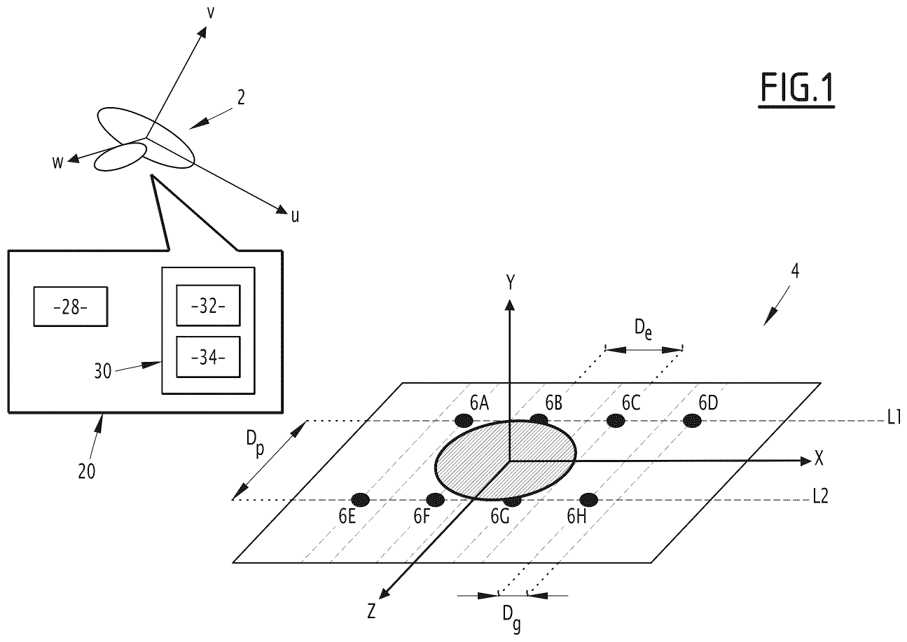

An aircraft 2 and a landing pad 4 are schematically represented in FIG. 1.

An aircraft is a means of transport capable of rising and moving at altitude, within the Earth's atmosphere.

For example, an aircraft is an airplane, a helicopter, or a drone.

More precisely, here, the aircraft 2 is a vertical landing or takeoff aircraft.

The aircraft 2 seeks to land on the landing pad 4.

For example, a known protocol for vertical landing on such a landing pad is described in the EASA document (PTS-VPT-DSN, available at the following address “https://www.easa.europa.eu/en/document-library/general-publications/prototype-technical-design-specifications-vertiports”) consists of the following steps:
approach of the aircraft 2 towards the landing pad 4 with an angle with respect to the ground of the landing pad 4 included between 3° and 30°, this angle is commonly called slope,
arrival at a decision point LDP (“Landing Decision Point”) located at a longitudinal distance usually included between 10 and 250 m from the landing pad 4, and
landing or go-around of the aircraft 2 depending on the situation.

Alternatively, the landing pad 4 can also be used for the takeoff of the aircraft 2 and has a shape adapted for vertical landing.

For example, the landing pad 4 has a disc shape and is reserved for the takeoff and landing of aircraft.

Depending on the cases, the position of an object designates either the geographical position or a localization with respect to the landing pad 4.

In the following description, a geographical position of an object is defined by three coordinates of the latter in a given reference.

In the following description, a localization of an object with respect to the landing pad 4 is defined as the coordinates of the projection of the object in a reference of the landing pad.

The reference of the landing pad is the reference formed by three orthogonal axes (X, Y, Z) of center O having coordinates (0,0,0) in the reference of the landing pad.

In the following description, the center O also represents the center of the disc formed by the landing pad 4.

As visible in FIG. 1, the landing pad 4 includes a plurality of reflective elements 6A, 6B, . . . , 6H for a radio signal.

Each reflective element 6A, 6B, . . . , 6H is arranged on the edge of the landing pad 4.

In the described example, only eight reflective elements 6A, 6B, . . . , 6H are represented but this number is not limiting, the number of reflective elements can vary according to needs.

Each reflective element 6A, 6B, . . . , 6H is, for example, a reflector.

A reflector is a device allowing an incident electromagnetic wave and especially a radar signal to be reflected.

Each reflector can be a trihedral reflector.

A trihedral reflector is well adapted for radar waves because it has the property of generating radar echoes of relatively high amplitude.

However, any form of reflector is conceivable here, notably parabolic, planar, or elliptical reflectors, as well as reflectors using passive, active electronic components, or with frequency-selective properties.

For example, such reflectors include Van Atta array type reflectors or Luneberg lenses.

Advantageously, the reflective elements 6A, 6B, . . . , 6H are arranged according to a specific spatial arrangement, which is now described.

In one embodiment, the spatial arrangement is such that a first half of the reflective elements 6A, 6B, 6C, 6D is aligned along a first line L1 tangent to landing pad 4 while a second half of the reflective elements 6E, 6F, 6G, 6H is aligned along a second line L2, distinct (not coinciding with) from the first line L1, also tangent to the landing pad 4.

Thus, the first half of the reflective elements 6A, 6B, 6C, 6D is arranged parallel to the second half of the reflective elements 6E, 6F, 6G, 6H on either side of the Z axis of the reference of the landing pad 4. Advantageously, the reflective elements 6A, 6B, 6C, and 6D will be offset by a distance D_{g} with respect to the reflective elements 6E, 6F, 6G, and 6H along a longitudinal axis U, so that each reflective element is detected at a different distance by the radar.

According to the described example, each of the reflective elements of the same line L1 or L2 are spaced from each other according to a predetermined line spacing De.

According to the described example, the predetermined line spacing De is the same for each of the lines L1 or L2 of reflective elements 8A, . . . , 8H.

By noting Dp the diameter of the landing pad 4 (which is generally substantially equal to 25 m), the line spacing De is, advantageously, substantially equal to one-third of the diameter of the landing pad Dp.

The aircraft 2 includes a localization device 20 configured to emit a radio signal to the landing pad 4 and receive a signal reflected by the landing pad 4 (and more precisely, at least one reflective element 6A, 6B, . . . , 6H) in order to deduce a position of the aircraft 2.

The localization device 20 includes a radio transmitter-receiver 28 and a calculator 30.

The radio transmitter-receiver 28 is configured to emit a radio signal from the aircraft 2 to the landing pad 4 and to receive a signal reflected by the landing pad 4.

For example, the radio transmitter-receiver 28 is a radar.

According to a preferred embodiment, the radar 28 is a continuous wave radar.

Such a radar is more often referred to as FMCW radar, which refers to the corresponding English designation “Frequency Modulated Continuous Wave”.

Such a radar operates here with millimeter or centimeter waves.

Preferably, the radio transmitter-receiver 28 is suitable for emitting or receiving signals with a frequency included between the X and W bands, i.e., between 8 Gigahertz (GHz) and 110 GHz.

For such a radar, emission and reception are almost simultaneous.

Typically, the radio transmitter-receiver 28 is suitable for emitting or receiving signals with a frequency chosen among the bands: X, K, Ka, Ku, and W.

Advantageously, the signals emitted or received by the radar 28 have a frequency substantially equal to 15 GHZ, 24 GHZ, 77 GHz, or 95 GHz.

In the following description, a radar reference 28 is an orthonormal reference (U, V, W) whose longitudinal axis U follows the angle of the trajectory of the aircraft 2 with respect to the landing pad 4 and whose origin is the localization device 20.

In the example of FIG. 1, the localization device 20 includes a calculator 30.

The calculator 30 includes, for example, a processor 32 and a memory 34 associated with the processor 32.

The calculator 30 is configured to process signals from the radio transmitter-receiver 28.

The calculator 30 is an electronic circuit designed to manipulate and/or transform data represented by electronic or physical quantities in the calculator's registers and/or memories into other similar data corresponding to physical data in the memory registers or other types of display, transmission, or storage devices.

As specific examples, the calculator 30 is implemented as a programmable logic component, such as an FPGA (Field Program Gate Array), or an integrated circuit, such as an ASIC (Application Specific Integrated Circuit).

Alternatively, when the method is implemented as one or more software, i.e., as a computer program, also called a computer program product, it is also suitable for being recorded on a medium, not shown, readable by a computer. The computer-readable medium is, for example, a medium suitable for storing electronic instructions and being coupled to a bus of a computer system. As an example, the readable medium is an optical disk, a magneto-optical disk, a ROM memory, a RAM memory, any type of non-volatile memory (for example FLASH or NVRAM), or a magnetic card. On the readable medium is then stored a computer program comprising software instructions.

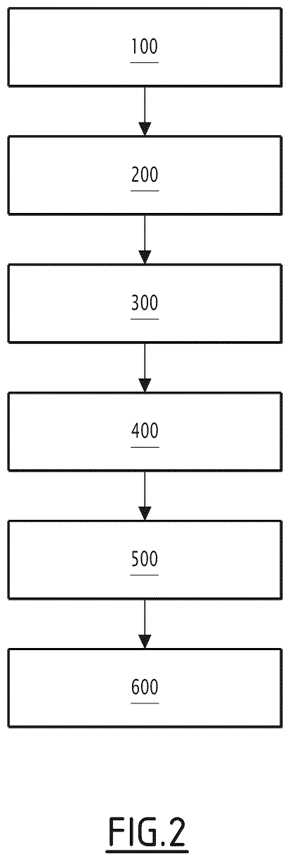

The operation of the localization device 20 is now described with reference to FIG. 2, which illustrates an example of implementation of a localization method.

The localization method includes an emission step 100, a reception step 200, a filtering step 300, a determination step 400, a selection step 500, and a localization step 600.

During the first emission step 100, the radio transmitter-receiver 28 emits a radio signal from the aircraft 2 to the landing pad 4.

The radio signal thus emitted interacts with the reflective elements 6A, 6B, . . . , 6H.

The reflective elements 6A, 6B, . . . , 6H return a reflected signal towards the aircraft 2 and more specifically to the radio transmitter-receiver 28.

During the reception step 200, the radio transmitter-receiver 28 receives a signal reflected by the landing pad 4.

According to the described example, the reflected signal includes a plurality of measurement points each defined by a position in the radar reference 28 and at least one characteristic physical magnitude.

Examples of the physical magnitudes are given in the filtering step 300.

Advantageously, the measurement points whose positions correspond to the positions of the reflective elements 6A, 6B, . . . , 6H are defined by at least one specific and identifiable characteristic magnitude.

During the filtering step 300, the calculator 30 filters the plurality of measurement points according to at least one criterion depending on the values of at least one characteristic magnitude.

In one embodiment, two criteria each depending on a respective characteristic magnitude are used.

For example, the two respective characteristic magnitudes are the reflected power and the doppler speed.

The reflected power of a measurement point corresponds to the power of the signal received by the radio transmitter-receiver 28 at this point and is generally expressed in watts (W).

The doppler speed of a measurement point is defined as the speed of the point along an axis passing through the point and the radar measuring the speed.

The speed is calculated from the doppler effect between the emitted signal and the signal received by the radio transmitter-receiver 28 and is generally expressed in m.s⁻¹.

In this embodiment, one of the two criteria used during the filtering step 300 is that the reflected power is included between two predetermined power thresholds while the other criterion is that the doppler speed is equal to the projection of the carrier's speed vector on a radar-reflector axis (reflector speed with respect to the ground is zero).

In the following description, the measurement points retained during the filtering step 300 are called filtered measurement points, the number of filtered measurement points being less than or equal to the number of measurement points.

During the determination step 400 of at least one set of filtered measurement points, the calculator 30 determines at least one set of measurement points respecting a condition of number and/or relative positioning of the filtered measurement points.

In the example of FIG. 1, a set of measurement points is composed of eight measurement points corresponding to the eight reflective elements 6A, 6B, . . . , 6H. The condition of number will then be eight.

In one embodiment, the criterion of relative positioning is that the maximum distance between two points of the same set 6A, 6B, . . . , 6H is less than 2 times the diameter of the landing pad Dp, which can be mathematically translated by the following equations:

$$max ( {r}_{i} ) - min ( {r}_{i} ) < 2 Dp$$

$$( max ( A {z}_{i} ) - min ( A {z}_{i} ) ) \times min ( {r}_{i} ) < 2 Dp$$

$$( max ( {El}_{i} ) - min ( {El}_{i} ) ) \times min ( {r}_{i} ) < 2 D p$$

with:
   rᵢ: vector whose terms are the radial distance between the aircraft 2 and each of the reflective elements 6A, 6B, . . . , 6H,
   Azᵢ: vector whose terms are the azimuth between the aircraft 2 and each of the reflective elements 6A, 6B, . . . , 6H, and
   Elᵢ: vector whose terms are the elevation between the aircraft 2 and each of the reflective elements 6A, 6B, . . . , 6H.

At the end of the determination step 400, a plurality of sets is determined.

During the selection step 500, the calculator 30 selects a set among the sets determined in the previous step.

For example, the selected set is the set among the determined sets minimizing a position offset between real measurement points and expected measurement points after reflection by the plurality of reflective elements 6A, 6B, . . . , 6H.

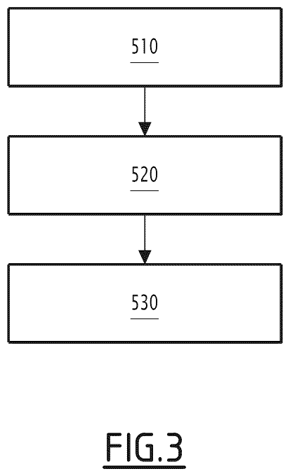

According to the embodiment of FIG. 3, the selection step 500 includes a sub-step of determination 510, a sub-step of calculation 520, and a sub-step of identification 530.

During the determination sub-step 510 of at least one base change variable between the radar reference 28 and the landing pad reference 4, the calculator 30 calculates at least one base change variable from the coordinates of the at least one determined set and the expected coordinates.

In the example, the base change variable is the rotation matrix R between the landing pad reference and the radar reference 28 and the translation matrix T between the landing pad reference 4 and the radar reference 28.

For example, the calculator 30 calculates the rotation matrix R and the translation matrix T between the landing pad reference and the radar reference 28 by implementing the following operations:
calculation of the centroids and associated with the coordinates of the reflective elements 6A, 6B, . . . , 6H of each of the determined sets according to the following equations:

$${μ}_{X} = \frac{1}{n} {\sum }_{i = 1}^{n} {X}_{i}$$

$${μ}_{Y} = \frac{1}{n} {\sum }_{i = 1}^{n} {Y}_{i}$$

with:
   Xᵢ the coordinates of the i-th reflective element of the studied determined set,
   Yᵢ the expected measurement points of each of the reflectors, and
   n: number of reflective elements of the studied determined set (n=8 in our example).

In the described example, the landing pad reference 4 being centered on the center of the landing pad 4, is zero due to the spatial arrangement also centered on the center of the landing pad 4.
calculation of the covariance matrix of X and Y according to the following equation:

$${Σ}_{X Y} = \frac{1}{n} {\sum }_{i} ( {Y}_{i} - {μ}_{Y} ) {( {X}_{i} - {μ}_{X} )}^{T}$$

with:
   Σ_{xy} covariance matrix of X and Y,
   X^{T} transpose of the matrix X,
   calculation of the singular value decomposition of:

$${Σ}_{X Y} = U D {V}^{T}$$

with:
   U, V: orthogonal matrices of the same dimension as, and
   D: diagonal matrix whose terms are the singular values of arranged in ascending order.
calculation of a matrix S according to the following equation:

$$S = \{ \begin{matrix}I , & if det ( {Σ}_{XY} ) \geq 0 \\ diag ( 1 , 1 , … , 1 , - 1 ) , & if det ( {Σ}_{XY} ) < 0\end{matrix}$$

with:
   I: identity matrix of the same dimension as,
   Diag: diagonal matrix of the same dimension as, and
   det: determinant function of a matrix.
   calculation of the rotation matrix R and the translation matrix T according to the following equations:

$$R = U S {V}^{T} ,$$

$$T = {μ}_{Y} - R {μ}_{X}$$

As previously indicated, in this example, R and T are the base change variables of base change between the landing pad reference 4 and the radar reference 28.

During the calculation sub-step 520, the calculator 30 calculates a plurality of position errors.

A position error is associated with a determined set.

Each position error is calculated based on the at least one base change variable calculated during the previous sub-step and the positions in the radar reference 28 of the points of each of the determined sets.

For example, the calculator 30 implements the following equation on each of the determined sets:

$${e}_{j}^{2} = \frac{1}{n} {\sum }_{i} {‖ {Y}_{i} - ( R {X}_{i} + T ) ‖}^{2} .$$

with:
   e²: quadratic deviation associated with a determined set j, and
∥X∥: the norm of X.

The calculator 30 thus obtains a position error for each determined set.

During the identification sub-step 530, the calculator 30 identifies a set among the determined sets.

According to the described example, the calculator 30 identifies the determined set whose position offset is the lowest.

The determined set thus identified is the selected set during the selection step 500.

During the localization step 600, the calculator 30 obtains a localization (x₂, y₂, z₂) of the aircraft 2 with respect to the landing pad 4.

For example, the calculator determines the localization (x₂, y₂, z₂) based on the positions of the measurement points of the selected set by applying the following equation:

$$( {x}_{2} , {y}_{2} , {z}_{2} ) = R {μ}_{X} + T$$

The calculator 30 thus obtains a precise localization of the aircraft 2 with respect to the landing pad.

The method just described is thus a method for locating a vertical landing aircraft with respect to a landing pad whose implementation is easy.

Indeed, the modification of an existing landing pad thus represents a moderate cost for an airport that would like to equip itself with this and is easy to implement.

Such dimensions are easily achievable in practice.

Moreover, the method presents a hybrid character since it allows a precise localization of the aircraft during landing and takeoff phases to be ensured.

Other embodiments benefiting from the same advantages are also conceivable.

For example, in one embodiment, the localization of the aircraft 2 is recorded in an accessible memory.

The calculator 30 is then configured to estimate the coherence of the evolution of the localization of the aircraft 2 based on the localizations and the speed of the aircraft 2.

1. A method for locating an aircraft with respect to a landing pad on which aircraft can land or take off, the landing pad including a plurality of reflective elements for a radio signal, the plurality of reflective elements being arranged according to a spatial arrangement, the method comprising:
emitting a radio signal from the aircraft to the landing pad;
receiving a signal reflected by the landing pad in response to the emitted radio signal, the reflected signal including a plurality of measurement points, each measurement point being defined by a position and presenting at least one characteristic magnitude;
filtering the plurality of measurement points according to at least one criterion depending on the at least one characteristic magnitude, to obtain filtered measurement points;
determining at least one set of filtered measurement points respecting a condition of number and/or relative positioning of the measurement points, to obtain determined sets;
selecting a set among the determined sets by minimizing a position offset between the real measurement points and the expected measurement points after reflection by the plurality of reflective elements, to obtain a selected set; and
localizing the aircraft with respect to the landing pad based on the positions of the measurement points of the selected set.

2. The method according to claim 1, wherein said selecting comprises:
determining at least one base change variable between the radar reference and the landing pad reference;
calculating a plurality of position errors, a position error being associated with a group of reflective elements and being calculated based on the at least one base change variable and the positions in the radar reference of the measurement points forming the group of reflective elements; and
identifying the selected set, the selected set being the group of reflective elements the position error of which is the lowest.

3. The method according to claim 1, wherein said filtering is implemented according to two criteria, each criterion depending on the value of a respective characteristic magnitude.

4. The method according to claim 3, wherein at least one characteristic magnitude is the reflected power or the Doppler speed.

5. The method according to claim 4, wherein a criterion is that the reflected power is comprised between two thresholds.

6. The method according to claim 1, wherein a diameter of the landing pad is defined, a condition of relative positioning being that the distance between the measurement points of the determined set is less than twice the diameter of the landing pad.

7. The method according to claim 1, wherein the radio signal belongs to a frequency band chosen among the X, K, Ka, Ku, and W bands.

8. The method according to claim 1, wherein according to the spatial arrangement, a first half of the reflective elements is aligned along a first line tangent to the landing pad and a second half of the reflective elements is aligned along a second line distinct from the first line and also tangent to the landing pad.

9. The method according to claim 8, wherein the reflective elements are offset by a distance with respect to the reflective elements along a longitudinal axis.

10. The method according to claim 8, wherein each of the reflective elements of the same line are spaced from each other according to a predetermined line spacing.

11. The method according to claim 1, wherein the aircraft is chosen from the group consisting of an airplane, a helicopter and a drone.

12. A localization device for an aircraft with respect to a landing pad on which aircraft can land or take off, the landing pad including a plurality of reflective elements for a radio signal, the plurality of reflective elements being arranged according to a spatial arrangement, the localization device comprising a calculator configured to:
emit a radio signal from the aircraft to the landing pad,
receive a signal reflected by the landing pad in response to the emitted radio signal, the reflected signal including a plurality of measurement points, each measurement point being defined by a position and presenting at least one characteristic magnitude,
filter the plurality of measurement points according to at least one criterion depending on the value of the characteristic magnitude, to obtain filtered measurement points,
determine at least one set of filtered measurement points respecting a condition of relative positioning of the measurement points, to obtain determined sets,
select a set among the determined sets by minimizing a position offset between the real measurement points and the expected measurement points after reflection by the plurality of reflective elements, to obtain a selected set, and
locate the aircraft with respect to the landing pad based on the positions of the measurement points of the selected set.

13. A landing pad on which aircraft can land or take off, the landing pad having a shape adapted for vertical landing and including a plurality of reflective elements for a radio signal arranged on an edge of the landing pad.

14. The landing pad according to claim 13, wherein at least one reflective element is a trihedral reflector.
